(19) United States
(12) Patent Application Publication
(10) Pub. No.: US 2014/0308463 A1
(43) Pub. Date: Oct. 16, 2014

(54) RECORDING MEDIUM FOR MANUFACTURING RECORDED MATERIAL, AND RECORDED MATERIAL

(71) Applicant: SEIKO EPSON CORPORATION, Tokyo (JP)

(72) Inventors: Kiyohiko TAKEMOTO, Matsumoto (JP); Masaru HOSHINO, Fujimi-machi (JP)

(73) Assignee: SEIKO EPSON CORPORATION, Tokyo (JP)

(21) Appl. No.: 14/230,509

(22) Filed: Mar. 31, 2014

(30) Foreign Application Priority Data
Apr. 10, 2013 (JP) 2013-082411

(51) Int. Cl. B41M 5/52; B41M 5/50

(52) U.S. Cl. CPC B41M 5/5254; B41M 5/508
USPC 428/32.21; 428/211.1

(57) ABSTRACT

A recording medium for manufacturing recorded material in which a face opposing to an image forming face of a recording medium, which has an image formed by an inkjet method, is bonded, includes a base material and an adhesive agent layer including polyisoprene.

### CROSS-REFERENCE TO RELATED APPLICATIONS

This application claims priority to Japanese Patent Application No. 2013-082411 filed on Apr. 10, 2013. The entire disclosure of Japanese Patent Application No. 2013-082411 is hereby incorporated herein by reference.

### BACKGROUND

1. Technical Field

The present invention relates to a recording medium for manufacturing recorded material, and a recorded material.

2. Related Art

In recent years, a service for printing user's image data and manufacturing a photograph bookbinding has been developed.

In the present, in the service for manufacturing a photograph book, it is desired to manufacture a photograph book in high quality with more excellent designability.

For example, a photograph book is manufactured by arranging and overlapping a plurality of printing objects in one side so as to bind them in the one side as a binding margin. Thus, the photograph book with many pages can be provided in light-weight. However, when the one side is arranged in the center and the right and left pages of the photograph book are faced each other, the two facing pages are discontinued visually in the binding side. Because of this, there was a problem that it was difficult to give expressions having an impact in a double-page spread, and as well as, there were the constraints of expressions because the layout was limited to one face.

On the other hand, as a photograph book, also, there was a method of manufacturing a photograph book. In the method, the plural numbers of image receiver papers in which an image was formed on one face were prepared, and in the state that the image receiver papers were folded, another image receiver paper was adhered onto the back surface on which an image was not formed (see e.g., Japanese Unexamined Laid-open Patent Application Publication No. 2011-240529). In the photograph book manufactured in such way, there was a case that it was not required to provide a wide binding margin, and in this case, the double-page spread was continued visually as one image so that the flexibility in the layout was increased. However, conventionally, when such method was used, there were problems such as the deterioration of workability due to the stickiness of the adhesive agent, and difficulty in position adjustment, etc.

Also, the aforementioned problems may be reduced by using hot-melt adhesive agent, but in this case, the following problems are raised. That is, when the thickness of the photograph book is relatively large, it is difficult to apply sufficient heat to near the central portion in the thickness direction so that it is difficult to obtain the sufficient adhesiveness (adhesion). Further, even if the sufficient adhesiveness (adhesion) may be obtained in near the central portion in the thickness direction, the excessive thermal energy is applied to near the surface so that it causes poor productivity of photograph books, and also, it is not preferable in the view of energy saving. In addition, it may cause harmful effect to an image, and furthermore, it may adversely affect durability of the photograph books.

### SUMMARY

An object of the present invention is to provide a recording medium for manufacturing recorded material that can be used to produce a recorded material (photograph book, etc.), in which a face opposing to an image forming face of a recording medium was bonded, with good productivity while effectively preventing it from occurring the problems of the deterioration of workability due to the stickiness of the adhesive agent and difficulty in position adjustment, etc. Further, an object of the invention is to provide a recorded material (photograph book, etc.) in which a face opposing to an image forming face of a recording medium was bonded while effectively preventing it from occurring the problems of difficulty in position adjustment, etc.

These objects are achieved by the invention as follows.

A recording medium for manufacturing recorded material being used for manufacturing a recorded material in which a face opposing to an image forming face in a recording medium, which has an image formed by the inkjet method, is bonded is characterized to include a base material and an adhesive agent layer including polyisoprene.

Because of this, it enables to provide a recording medium for manufacturing recorded material that can be used to produce a recorded material (photograph book, etc.), in which a face opposing to an image forming face of a recording medium was bonded, with good productivity while effectively preventing it from occurring the problems of the deterioration of workability due to the stickiness of the adhesive agent and difficulty in position adjustment, etc.

In the recording medium for manufacturing recorded material in accordance with an aspect of the invention, it is preferable that a weight-average molecular weight of the polyisoprene is more than or equal to 100,000 and less than or equal to 500,000.

Therefore, by only applying pressure without heating and at room temperature of less than or equal to 40° C., the recording medium for manufacturing recorded material having excellent adhesiveness can be obtained.

In the recording medium for manufacturing recorded material in accordance with another aspect of the invention, in addition to the polyisoprene, the adhesive agent layer preferably includes a water-soluble resin.

Because of this, it can provide an adhesive agent layer with particularly excellent adhesiveness. Therefore, higher adhesion strength can be obtained in the recorded material, and also, in the production of the recorded material, sufficient adhesion strength can be obtained by lower pressure so as to attain the miniaturization of the production device of the recorded material and simplifying a structure.

In the recording medium for manufacturing recorded material in accordance with another aspect of the invention, the adhesive agent layer preferably includes polyvinyl alcohol as the water soluble resin.

Because of this, the adhesiveness in the adhesive agent layer can be improved.

In the recording medium for manufacturing recorded material, when a content rate of the polyisoprene in the adhesive agent layer is X_{A} [wt. %] and the content rate of polyvinyl alcohol in the adhesive agent layer is X_{B} [wt. %], it is preferable that the relationship of 3 X_{A}/X_{B}≦19 is satisfied.

Because of this, excellent adhesiveness can be provided by the adhesive agent layer.

In the recording medium for manufacturing recorded material in accordance with another aspect of the invention, a content rate of the polyisoprene in the adhesive agent layer is preferably more than or equal to 75 mass % and less than or equal to 95 mass %.

In the recording medium for manufacturing recorded material in accordance with another aspect of the invention, the base material is preferably a roll paper.

Because of this, even when the roll type of the recording medium for manufacturing recorded material is stored in the state that it was wound (in the state that the surface, on which the adhesive agent layer is formed, and the opposite side of the surface are contacted. Specifically, in the state that it is tighten up by relatively high pressure.), the occurrence of unexpected adhesion (blocking) between the adhesive agent layer and the base material which is opposed to the layer can be prevented, and when necessary (at the time of the production of recorded material), sufficient adhesion strength can be easily obtained by pressure. That is, a remarkable effect of the invention is attained when the base material is a roll paper. Further, when the base material is a roll paper, in the state that the roll type of the recording medium for manufacturing recorded material was wound, the appropriate gripping force is obtained so that it effectively prevents the wound recording medium for manufacturing recorded material from loosening unexpectedly. Therefore, storing the recording medium for manufacturing recorded material can be appropriately performed.

In the recording medium for manufacturing recorded material in accordance with another aspect of the invention, a thickness of the adhesive agent layer is preferably more than or equal to 1 μm and less than or equal to 10 μm.

Because of this, it can provide particularly excellent adhesion strength in the recorded material finally obtained and particularly excellent durability of the recorded material.

A recorded material in accordance with an aspect of the invention is provided by bonding a face opposing to an image forming face of a recording medium, which has an image formed by the inkjet method. The recording medium is characterized to include a base material and an adhesive agent layer which including polyisoprene.

Therefore, it is effectively prevented from occurring the problem of difficulty in position adjustment, etc. so as to provide the recorded material (photograph book, etc.) in which a face opposing to an image forming face of a recording medium was bonded.

### BRIEF DESCRIPTION OF THE DRAWINGS

Referring now to the attached drawings which form a part of this original disclosure:

FIG. 1 is a cross-sectional view schematically showing an example of a recording medium for manufacturing recorded material of an embodiment; and

FIG. 2 is a cross-sectional view schematically showing an example of a recorded material.

### DETAILED DESCRIPTION OF EXEMPLARY EMBODIMENTS

Hereinafter, the preferred embodiments of the present invention will be described in reference to the attached drawings.

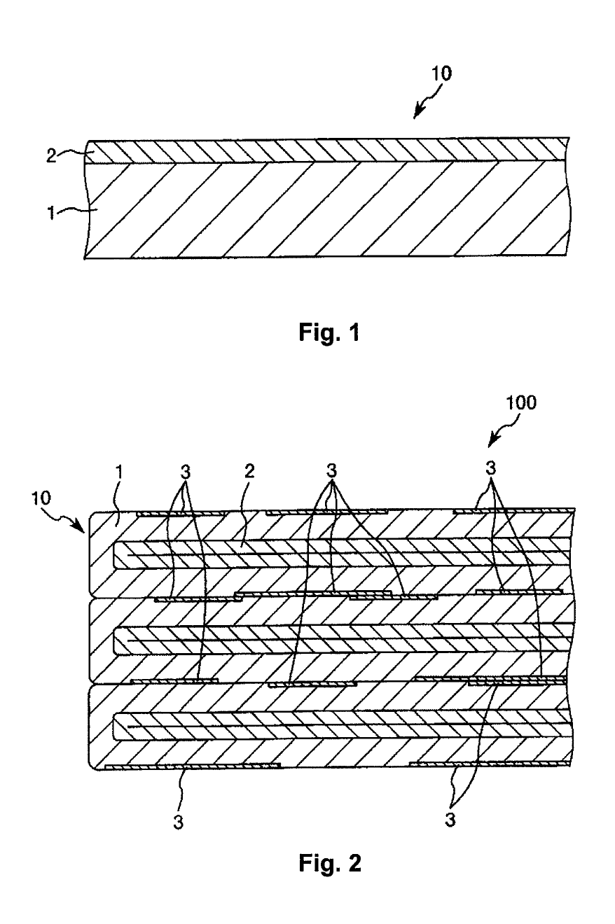

FIG. 1 is a cross-sectional view schematically showing an example of a recording medium for manufacturing recorded material of the embodiment, and FIG. 2 is a cross-sectional view schematically showing an example of a recorded material.

### Recording Medium for Manufacturing Recorded Material

Initially, the recording medium for manufacturing recorded material of the embodiment will be described.

A recording medium for manufacturing recorded material is used for manufacturing a recorded material, in which a face opposing to an image forming face of a recording medium such as a paper, which has an image formed by the inkjet method, was bonded.

In the embodiment, the image was formed by the inkjet method. Because of this, the size range of the applied paper (recording medium) can be more widened. For example, a long recording medium (roll paper, etc.) can be appropriately used. A seamless image can be appropriately formed in the double-page spread so that excellent dynamic feel and excellent luxurious feel of an image can be specifically obtained in the finally obtained recorded material. Also, relatively smaller device can be used as an image forming device. Further, various types of recording mediums (base material) such as ultra-bright, semi-gloss, mat tone, etc. can be appropriately applied so that it is impossible to be printed by the offset printing or the laser printer. Also, it is possible to make various feels of material of the collections of works that is usable in the field so-called fine arts.

As shown in FIG. 1, a recording medium for manufacturing recorded material 10 has a base material 1 and an adhesive agent layer 2.

The base material 1 has a function to retain the adhesive agent layer 2 as described layer.

As the base material 1, for example, it includes various kinds of papers such as plain paper, coated paper, photo paper, offset printing paper, etc., and plastic film, metal foil, fabric, etc.

Further, as the base material 1, a roll paper may be used. Because of this, even when the roll type of the recording medium for manufacturing recorded material 10 is stored in the state that it was wound (in the state that the surface, on which the adhesive agent layer 2 is formed, and the opposite side of the surface are contacted. Specifically, in the state that it is tighten up by relatively high pressure.), the occurrence of unexpected adhesion (blocking) between the adhesive agent layer 2 and the base material 1 which is opposed to the layer can be prevented, and when necessary (at the time of the production of recorded material 100), sufficient adhesion strength can be easily obtained by pressure. That is, a remarkable effect of the embodiment is attained when the base material 1 is a roll paper. Further, when the base material 1 is a roll paper, in the state that the roll type of the recording medium for manufacturing recorded material 10 was wound, the appropriate gripping force is obtained so that it effectively prevents the wound recording medium for manufacturing recorded material 10 from loosening unexpectedly. Therefore, storing the recording medium for manufacturing recorded material 10 can be appropriately performed.

The thickness of the base material 1 is not limited, but it is preferably more than or equal to 30 μm, and more preferably, it is more than or equal to 50 μm and less than or equal to 200 μm. Because of this, in the case that the thickness of the base material 1 is relatively large, when the hot-melt adhesive agent is used, it is difficult to apply sufficient heat to near the central part in the thickness direction, and it is difficult to obtain sufficient adhesiveness (adhesion), and also, it is a disadvantage in the view of the production of the recorded material 100 or the energy saving. However, in the embodiment, even when the thickness of the base material 1 is relatively large as described above, the occurrence of the aforementioned problems can be surely prevented. That is, a remarkable effect of the embodiment is attained when the thickness of the base material 1 is relatively large as described above. Also, when the thickness of the base material 1 is a value within the aforementioned ranges, it can provide particularly excellent luxurious feel and excellent durability of a recorded material 100 which is manufactured by using the recording medium for manufacturing recorded material 10.

In the production of the recorded material 100, the adhesive agent layer 2 has a function to bond a face opposing to an image forming face of the base material 1.

And, the adhesive agent layer 2 is composed of a material including polyisoprene. Because of this, an adhesive agent layer 2 suppresses stickiness so that sufficient adhesion strength can be obtained by pressure. Also, even when the thickness of the recorded material 100 to be manufactured is relatively large (many layers to be adhered are laminated), the uniformity of pressure to the whole area can be high so that variability of adhesion strength can be suppressed in each part. Further, heating is not required during the adhesion so that it is preferred in the view of energy saving. Further, polyisoprene is a material having high flexibility so that it is prevented that the elasticity of the recording medium for manufacturing recorded material 10 unnecessarily becomes high so as to secure easy handling, and it can prevent the adhesive agent layer 2 from breaking due to bending of the recording medium for manufacturing recorded material 10 so that excellent reliability and excellent durability of the recorded material 100 and the recording medium for manufacturing recorded material 10 can be provided. Further, by including polyisoprene, during the production of the recorded material 100, sufficient adhesion strength can be easily obtained by pressure, and also, when the recording medium for manufacturing recorded material 10 was stored, when the recording medium for manufacturing recorded material 10 were stacked and stored, and when the rolled type of the recording medium for manufacturing recorded material 10 was wound up, the occurrence of unexpected adhesion (blocking) is surely prevented. Further, the adhesive agent layer 2 composed of a material including polyisoprene has appropriate gripping force so that for example, when an image is formed on the recording medium for manufacturing recorded material 10, which forms the adhesive agent layer 2, by using the inkjet printer, excellent conveyance of the recording medium for manufacturing recorded material 10 can be realized and it can surely prevent the rollers of the inkjet printer from running idle, and the desired image can be surely formed on a target region. Furthermore, by including the adhesive agent 2 composed of a material including polyisoprene, it can surely prevent the inside of the inkjet printer from generating the paper powder derived from the base material 1 so that it can surely prevent the inkjet printer from occurring malfunction, failure, etc. Further, the particular odor such as vinyl acetate series or acrylic resins that are commonly used as an adhesive agent is not generated.

Polyisoprene is a compound having a structure polymerizing isoprene (2-methyl-1,3-butadiene).

It is preferable that the weight-average molecular weight of polyisoprene in the adhesive agent layer 2 is more than or equal to 100,000 and less than or equal to 500,000. Because of this, higher adhesion strength in the recorded material can be obtained, and also, in the production of the recorded material, sufficient adhesion strength can be obtained by lower pressure so as to attain the miniaturization of the production device of the recorded material and simplifying a structure. Further, by only applying pressure without heating and at room temperature of less than or equal to 40° C., the recording medium for manufacturing recorded material having excellent adhesiveness can be obtained. On the other hand, when the weight-average molecular weight of polyisoprene is less than the aforementioned lower limit, the flexibility of the formed adhesive agent layer becomes insufficient, it cannot be adhered by only the pressure under room temperature at less than or equal to 40° C. without heating. Further, when the weight-average molecular weight of polyisoprene exceeds the aforementioned upper limit, the elasticity of the recording medium for manufacturing recorded material 10 becomes large, the treatability of the recording medium for manufacturing recorded material 10 and the recorded material 100 of the embodiment by using the recording medium for manufacturing recorded material 10 is reduced, and there is a possibility that the reliability and durability of the recorded material 100 and the recording medium for manufacturing recorded material 10 may be reduced.

By the way, for example, the weight-average molecular weight can be calculated by the gel permeation chromatography (GPC) measurement of the polyisoprene polymer part by using Tosoh Corporation, HLC-8320GPC. In the present application, the phrase “weight-average molecular weight” denotes the value calculated by aforementioned way unless otherwise specifically noted.

The content rate of polyisoprene in the adhesive agent layer 2 is preferably more than or equal to 75 mass % and less than or equal to 95 mass %.

Further, the adhesive agent layer 2 may include a water-soluble resin. Because of this, it can provide excellent adhesiveness by the adhesive agent layer 2. Therefore, high adhesion strength can be obtained in the recorded material 100, and also, in the production of the recorded material 100, sufficient adhesion strength can be obtained by lower pressure so that it can provide the miniaturization of the production device of the recorded material 100 and simplify the structure.

As the water-soluble resin included in the adhesive agent layer 2, for example, it preferably includes polyvinyl alcohol. Because of this, a remarkable effect is attained by including the water-soluble resin as described above.

An average molecular weight of polyvinyl alcohol is preferably more than or equal to 400 and less than or equal to 2,000. When the average molecular weight of polyvinyl alcohol is less than the aforementioned lower limit, in the state that the roll type of the recording medium for manufacturing recorded material 10 was wound, the unexpected adhesion (blocking) between the adhesive agent layer and the base material, which is opposed to the layer, is easily occurred. Also, when the average molecular weight of polyvinyl alcohol exceeds the aforementioned upper limit, it appears that the adhesiveness by the adhesive agent layer 2 tends to be reduced.

The content rate of polyvinyl alcohol in the adhesive agent layer 2 is preferably more than or equal to 5 mass % and less than or equal to 25 mass %. Because of this, the adhesiveness by the adhesive agent layer 2 can be further improved. On the other hand, when the content rate of polyvinyl alcohol is less than the aforementioned lower limit, it appears that the adhesiveness by the adhesive agent layer 2 tends to be reduced. Also, when the content rate of polyvinyl alcohol exceeds the aforementioned upper limit, in the case that the recording mediums for manufacturing recorded material 10 were stacked and stored, in the state that the roll type of the recording medium for manufacturing recorded material 10 was wound, the unexpected adhesion (blocking) between the adhesive agent layer and the base material, which is opposed to the layer, is easily occurred.

Further, when the content rate of polyisoprene in the adhesive agent layer 2 is X_{A} [mass %], and when the content rate of polyvinyl alcohol in the adhesive agent layer 2 is X_{B} [mass %], it is preferable that the relationship of 3≦X_{A}/X_{B}≦19 is satisfied. On the other hand, when X_{A}/X_{B} is less than the aforementioned lower limit, in the case that recording mediums for manufacturing recorded material 10 were stacked and stored, in the state that the roll type of the recording medium for manufacturing recorded material was wound, the unexpected adhesion (blocking) between the adhesive agent layer and the base material, which is opposed to the layer, is easily occurred. Further, when X_{A}/X_{B} exceeds the aforementioned upper limit, it appears that the adhesion by the adhesive agent layer 2 tends to be reduced.

The adhesive agent layer 2 may be a component other than polyisoprene. As such components, for example, it includes surfactant, antiseptic and fungicide, pH adjusting agent, antioxidant, metal trapping agent, humectant, dispersant, dispersion aid, filler, adhesion accelerator, aggregation prevention agent, photo-curable resin, thermosetting resin, polymerization initiator, polymerization inhibitor, and like.

The thickness of the adhesive agent layer 2 is not particularly limited, but it is preferably more than or equal to 1 μm and less than or equal to 10 μm. Therefore, it can provide particularly excellent adhesion strength in the finally obtained recorded material 100 and it can provide particularly excellent durability of the recorded material 100.

The adhesive agent layer 2 may be applied to whole surface of the base material 1 or may be only applied to a part of the surface. For example, the adhesive agent layer 2 may be applied in the configuration of linear, point-like (dots), and the like on the base material 1. Further, in the production of the recorded material 100, the adhesive agent layer 2 may be applied to only one face among the faces of recording medium for manufacturing recorded material 10 to be bonded.

Specifically, in comparison with the case that the adhesive agent layer 2 is only applied to an edge part of the base material (recording medium) 1, when the adhesive agent layer 2 is applied to whole surface of the base material 1, it surely prevents the recorded material from generating a gap in the region that is not adhered, and moreover, it can particularly facilitate turning-over of pages. Further, particularly excellent luxurious feel can be provided in the finally obtained recorded material 100.

### Composition Containing Adhesive Agent

Next, the composition containing adhesive agent that can be appropriately used in the production of the recording medium for manufacturing recorded material of the embodiment will be described.

The composition containing adhesive agent is normally liquid form.

Polyisoprene may be included in any configuration in the composition containing adhesive agent, but it is preferably included as dispersoid to be dispersed in the dispersion medium. Therefore, drying efficiency is improved, and the effect that an adhesive agent layer pattern can be precisely formed is obtained.

When polyisoprene is included as dispersoid in the composition containing adhesive agent, the average particle diameter of particles of polyisoprene is preferably more than or equal to 10 nm and less than or equal to 1 μm, and more preferably, it is more than or equal to 10 nm and less than or equal to 1 μm. When the average particle diameter of particles of polyisoprene is less than the aforementioned lower limit, the stickiness of the adhesive agent layer formed by the composition containing adhesive agent becomes large so that in the case that the roll type of the recording medium for manufacturing recorded material was wound, there is a possibility that the unexpected adhesion (blocking) may be generated. Further, when the average particle diameter of the particles of polyisoprene exceeds the aforementioned upper limit, there is a possibility that excellent adhesiveness may not be obtained.

By the way, the average particle diameter is measured by, for example, a particle size analyzer using a dynamic light scattering method. Pure water is added to emulsion by 100 times, and Nanotrac UPA-EX150 (manufactured by Nikkiso Co., Ltd.) is used for the measurement and it can be shown in 50 mass % average particle diameter. By the way, in the present application, the phrase “average particle diameter” denotes the value calculated by the aforementioned way unless otherwise specifically noted.

The content rate of polyisoprene in the composition containing adhesive agent is preferably more than or equal to 2.5 mass % and less than or equal to 25 mass %. When the content rate of polyisoprene is less than the aforementioned lower limit, in the case that an adhesive agent layer is formed by the composition containing adhesive agent, there is a possibility that the productivity to secure the thickness of the adhesive agent layer may be reduced. Further, when the content rate of polyisoprene exceeds the aforementioned upper limit, the stickiness of the composition containing adhesive agent becomes high so that for example, in the case that the production of the recording medium for manufacturing recorded material 10 of the embodiment is performed, there is a possibility that the treatability (for example, discharge stability by the inkjet method, etc.) of the composition containing adhesive agent may be reduced.

The composition containing adhesive agent includes at least polyisoprene, but it may be possible to include additional other components.

For example, a solvent for solving polyisoprene and a dispersion medium for dispersing polyisoprene may be included. As the solvent and the dispersion medium, water and water-soluble organic solvent in which the boiling point of approximately 1 atm is more than or equal to 70° C. and less than or equal to 250° C. can make resin to be existed stably in the composition containing adhesive agent, and also, in the case that the composition containing adhesive agent is discharged by the inkjet method, it provides excellent discharge stability of the composition containing adhesive agent, and in addition, it also provides excellent volatility of the composition containing adhesive agent so that it is possible to form an adhesive agent layer pattern with high accuracy. Therefore, it is preferable.

The aforementioned water-soluble organic solvent is preferably an aqueous liquid including at least one selected from lactam, carboxylic acid ester, alkylene glycol ether, and alcohol. Among them, the aqueous liquid including 2-pyrrolidone (γ-butyrolactam), lactic acid ester, alkylene glycol ether, and alcohol is more preferable.

As the aforementioned water-soluble organic solvent, it is not limited to the followings, but for example, it includes ethanol (boiling point 78° C.), N-methyl-2-pyrrolidone (boiling point 202° C.), N-methyl-2-pyrrolidone (boiling point 212° C.), 2-pyrrolidone (boiling point 245° C.), dimethyl sulfoxide (boiling point 189° C.), methyl lactate (boiling point 145° C.), ethyl lactate (boiling point 155° C.), isopropyl lactate (boiling point 168° C.), butyl lactate (boiling point 188° C.), ethylene glycol monomethyl ether (boiling point 124° C.), ethylene glycol dimethyl ether (boiling point 85° C.), ethylene glycol monomethyl ether acetate (boiling point 145° C.), diethylene glycol monomethyl ether (boiling point 194° C.), diethylene glycol dimethyl ether (boiling point 162° C.), diethylene glycol ethyl methyl ether (boiling point 176° C.), diethylene glycol diethyl ether (boiling point 189° C.), propylene glycol monomethyl ether (boiling point 120° C.), propylene glycol dimethyl ether (boiling point 97° C.), dipropylene glycol monomethyl ether (boiling point 188° C.), dipropylene glycol dimethyl ether (boiling point 171° C.), 1,4-dioxane (boiling point 101° C.), ethylene glycol (boiling point 197° C.), diethylene glycol (boiling point 244° C.), propylene glycol (boiling point 188° C.), dipropylene glycol (boiling point 232° C.), 1,3-propanediol (boiling point 212° C.), 1,4-butanediol (boiling point 230° C.), hexylene glycol (boiling point 198° C.), 2,3-butanediol (boiling point 77° C.), n-butanol (boiling point 118° C.), 1,2-hexanediol (boiling point 224° C.), 1,2-pentanediol (boiling point 206° C.), diethylene glycol monobutyl ether (boiling point 116° C.), and diethylene glycol monopropyl ether (boiling point 153° C.).

The water-soluble organic solvent in which the boiling point of approximately 1 atm is more than or equal to 70° C. and less than or equal to 250° C. may be used by 1 kind singly or more than 2 kinds.

Specifically, the composition containing adhesive agent preferably includes water as dispersion medium to disperse the particles of polyisoprene. Because of this, sufficient excellent dispersion stability of the particles of polyisoprene in the composition containing adhesive agent can be obtained so that the production of the recording medium for manufacturing recorded material 10 can be appropriately performed. Further, since water has appropriate volatility, it is more securely prevented from the change in composition during the storage, and it is easily removed during the production of the recording medium for manufacturing recorded material 10 so that it is an advantage to improve the productivity of the recording medium for manufacturing recorded material 10. Also, a load to the environment can be reduced by using water.

Further, in the case that polyisoprene is includes as dispersoid in the composition containing adhesive agent, when the composition containing adhesive agent includes the water-soluble resin as described above, particularly excellent dispersion stability of the aforementioned dispersoid and particularly excellent storage stability of the composition containing adhesive agent can be provided. As a result, for example, in the case that the composition containing adhesive agent is discharged by the inkjet method, particularly excellent discharge stability of the composition containing adhesive agent can be provided.

When the composition containing adhesive agent includes the water-soluble resin, in the composition containing adhesive agent, it is preferably included in the state that the water-soluble resin was solved. Because of this, the aforementioned effect is more surely attained.

Also, by including polyisoprene and polyvinyl alcohol in the relationship of the aforementioned content rate, the aforementioned effect can be obtained in the recording medium for manufacturing recorded material 10, and in the case that polyisoprene is included as dispersoid in the composition containing adhesive agent, more excellent dispersion stability of the aforementioned dispersoid and more excellent storage stability of the composition containing adhesive agent can be provided so that for example, in the case that the composition containing adhesive agent is discharged by the inkjet method, more excellent discharge stability of the composition containing adhesive agent can be provided.

Further, the composition containing adhesive agent of the embodiment may include a surfactant. Because of this, particularly excellent adhesion by the composition containing adhesive agent can be obtained. Further, when the composition containing adhesive agent includes water-soluble resin, in the case that polyisoprene is included as dispersoid in the composition containing adhesive agent, particularly excellent dispersion stability of the aforementioned dispersoid and particularly excellent storage stability of the composition containing adhesive agent can be provided. As a result, for example, in the case that the composition containing adhesive agent is discharged by the inkjet method, particularly excellent discharge stability of the composition containing adhesive agent can be provided. Further, in the production of the recording medium for manufacturing recorded material 10, the occurrence of unexpected variability for the film thickness of the formed adhesive agent layer 2 can be effectively prevented.

As the surfactant, for example, cationic surfactant, anionic surfactant, nonionic surfactant, amphoteric surfactant, etc. can be used. As a preferable surfactant, it includes at least one surfactant selected from a group including acetylene glycol-based surfactant and silicone-based surfactant.

As the acetylene glycol-based surfactant, for example, it includes 2,4,7,9-tetramethyl-5-decyne-4,7-diol, 3,6-dimethyl-4-octyne-3,6-diol, 3,5-dimethyl-1-hexyne-3-ol, 2,4-dimethyl-5-hexyne-3-ol. As a commercially available acetylene glycol-based surfactant, for example, Olfine E1010, STG, Y, Surfinol 104E, 104H, 104A, 104BC, 104DPM, 104PA, 104PG-50, 104S, 420,465,485, TG, SE, SE-F, 61,82, DF-110D (all trade names, manufactured by Nissin Chemical Industry Co., Ltd.), Acetylenol E00, E00P (all trade names, manufactured by Kawaken Fine Chemicals Co. Ltd.) can be used.

As a silicon-based surfactant, polysiloxane compound is preferably used, and as a specific example of polysiloxane compound, it includes polyether-modified organosiloxane. As a commercially available silicon-based surfactant, BYK-306, BYK-307, BYK-333, BYK-341, BYK-345, BYK-346, BYK-347, BYK-348, BYK-UV3500, 3510, 3530, 3570 (all trade names, manufactured by BYK Japan KK) can be used.

More preferable surfactant is the combination of silicon-based surfactant and acetylene glycol-based surfactant in which the HLB value is less than or equal to 17.

Further, the surface tension of the aforementioned composition containing adhesive agent is preferably in the range of more than or equal to 23.0 mN/m and less than or equal to 40.0 mN/m by combining the aforementioned water-soluble organic solvent and surfactant. It is more preferably in the range of more than or equal to 25.0 mN/m and less than or equal to 35.0 mN/m. When the surface tension of the composition containing adhesive agent is within the aforementioned ranges, excellent discharge stability in an inkjet head can be provided.

The composition containing adhesive agent of the embodiment may include components other than the aforementioned components (other components). As such components, for example, it includes antiseptic and fungicide, pH adjusting agent, antioxidant, metal trapping agent, humectant, dispersant, dispersion aid, filler, adhesion accelerator, aggregation prevention agent, photo-curable resin, thermosetting resin, polymerization initiator, polymerization inhibitor, and like. As the antiseptic and fungicide, for example, it includes sodium benzoate, pentachlorophenol sodium, 2-pyridinethiol-1-oxide sodium, sodium sorbate, sodium dehydroacetate, 1,2-dibenzothiazolin-3-one (Proxel-CRL, Proxel-BDN, Proxel-GXL, Proxel-XL2, Proxel-TN manufactured by Arch Chemicals, Inc.).

As the pH adjusting agent, for example, it includes sodium hydroxide, potassium hydroxide, and the like such as inorganic alkali, ammonia, diethanolamine, triethanolamine, tri-isopropanol amine, morpholine, potassium dihydrogen phosphate, and disodium hydrogen phosphate.

As the metal-trapping agent, for example, it includes disodium ethylene-diamine-tetraacetate, and the like.

The composition containing adhesive agent of the embodiment can be applied to the base material 1 in any method. For example, various application methods such as bar coating, spin coating, roll coating, slit coating, brushing, etc., and various printing methods such as offset printing, gravure printing, inkjet method, etc., can be performed, but the inkjet method is preferable. Therefore, extremely easy pattern application on the adhesive agent layer can be realized, and many kinds of photograph books in small quantities can be efficiently produced with low price in short time of period.

The application amount of the composition containing adhesive agent to the base material 1 per unit area is not particularly limited, but it is preferably more than or equal to 0.1 g/m² and less than or equal to 20 g/m², and more preferably, it is more than or equal to 0.5 g/m² and less than or equal to 10 g/m². Because of this, particularly excellent adhesion strength can be provided in the finally obtained recorded material 100.

The application of the composition containing adhesive agent to the base material 1 may be performed before the image formation (photographic printing) to the base material 1 or may be performed after the image formation (photograph printing) to the base material 1. However, it is preferable to be performed before the image formation (photographic printing) to the base material 1. Therefore, the recording medium for manufacturing recorded material of the embodiment can be preliminary prepared for producing the recorded material in which the image to be formed is normally different depending on the customer so that the delivery time of the recorded material can be shortened.

### Recorded Material

Next, the recorded material will be described.

The recorded material of the embodiment is produced by bonding the face opposing to the image forming face of the recording medium which has an image formed by the inkjet method, and the recording medium has the adhesive agent layer composed of a material including the base material and polyisoprene. That is, the recorded material of the embodiment is in the state that a print part was formed on the face opposing to the adhesive agent layer of the aforementioned recording medium for manufacturing recorded material of the embodiment, and the recording medium for manufacturing recorded material is bonded on the face provided with the adhesive agent layer. Therefore, it can provide the recorded material (photograph book, etc.) in which the face opposing to the image forming face of the recording medium for manufacturing recorded material was bonded while the occurrence of the problem of difficulty in position adjustment, etc. is effectively prevented.

By the way, in the embodiment, as a recorded material, it may be anything in which the face opposing to the image forming face of the recording medium, which has an image formed by the inkjet method, was bonded. Specifically, for example, it includes a photograph book, a calendar, a greeting card, a catalog, an independent book, a paperback book, a dissertation, etc.

As shown in FIG. 2, in the recorded material 100 of the present embodiment, the recording medium for manufacturing recorded material 10 having the base material, which forms the print part 3, and the adhesive agent layer 2 is alternately folded in mountain fold and valley fold in a predetermined width, and it has a configuration bonding the parts each other where the adhesive agent layer 2 of the recording medium for manufacturing recorded material 10 was formed.

In the configuration shown in FIG. 2, as the sake of simplicity, it shows that the page number of the recorded material 100 (including front cover, back cover) is 6 pages, but it is not limited this. The page number of the recorded material 100 is preferably more than or equal to 4 pages, and more preferably, it is more than or equal to 8 pages and less than or equal to 80 pages. Therefore, when the page number of the recorded material is relatively large, in the case that the hot-melt adhesive agent is used for manufacturing the recorded material, it is difficult to apply heat to near the central part in the thickness direction so that it is difficult to have sufficient high adhesiveness (adhesion) and it is a disadvantage in the views of productivity of the recorded material, energy saving, or durability of the recorded material, but in the embodiment, even when the page number of the recorded material is relatively large as described above, the occurrence of the aforementioned problems can be surely prevented. That is, a remarkable effect of the embodiment is attained when the page number of the recorded material is relatively large as described above. Also, when the page number of the recorded material is a value'within the aforementioned ranges, it can provide particularly excellent luxurious feel and excellent durability of the recorded material.

An image provided as the print part 3 may be recorded in a recording media such as SD card, USB memory, DVD, and the like that the user (customer) brings, or the data may be received through the internet connection, etc.

In the state that the image (print part) was formed on the face opposing to the face provided with the adhesive agent layer of the aforementioned recording medium for manufacturing recorded material of the embodiment, the recorded material of the embodiment is manufactured by bonding the face opposing to the image forming face of the recording medium for manufacturing recorded material.

In the state that the faces opposing to the faces, on which the print parts 3 of the recording medium for manufacturing recorded material were formed, are opposed each other, bonding the recording medium for manufacturing recorded material 10 are performed by applying pressure.

In this case, the pressure is preferably more than or equal to 3 kgf/cm² and less than or equal to 30 kgf/cm², and more preferably, it is more than 7 kgf/cm² and less than or equal to 13 kgf/cm². Therefore, it can surely manufacture a recorded material 100 having high adhesion strength with excellent productivity while preventing an increase in size. On the other hand, when the pressure is lower than the aforementioned lower limit, there is a possibility that may be difficult to obtain sufficient adhesion strength depending on patterns, application amount, etc. of the adhesive agent layer 2. Further, when the pressure exceeds the aforementioned upper limit, there is a possibility that may be generated color migration to another page depending on ink components, and like used for an image formation.

The thickness of the recorded material 100 is not particularly limited, but it is preferably more than or equal to 3 mm, and more preferably, it is more than or equal to 5 mm and less than or equal to 50 mm. Therefore, when the thickness of the recorded material is relatively large, in the case that the hot-melt adhesive agent is used for manufacturing the recorded material, it is difficult to apply heat to near the central part in the thickness direction so that it is difficult to have sufficient high adhesiveness (adhesion) and it is a disadvantage in the views of productivity of the recorded material, energy saving, or durability of the recorded material, but in the embodiment, even when the thickness of the recorded material is relatively large as described above, the occurrence of the aforementioned problems can be surely prevented. That is, a remarkable effect of the embodiment is attained when the thickness of the recorded material is relatively large as described above. Also, when the thickness of the recorded material is a value within the aforementioned ranges, it can provide particularly excellent luxurious feel and excellent durability of the recorded material.

The above description of the embodiment was discussed based on the preferable embodiments, but the embodiment is not limited to these embodiments.

For example, in the aforementioned embodiments, it was described in the case that the recorded material was manufactured by using one recording medium for manufacturing recorded material. However, in the production of the recording medium, the plural numbers of the recording mediums for manufacturing recorded material may be used. For example, in the recorded material of the embodiment, it may be manufactured by bonding the faces (face opposite side of the image forming face) of these recording mediums for manufacturing recorded material, on which the adhesive agent layer was formed, each other. Also, the adhesive agent layer may be formed on at least one face among the faces that are bonded.

### EXAMPLES

### Example 1

1. Manufacturing Composition Containing Adhesive Agent

The composition containing adhesive agent was manufactured as follows.

Average particle diameter: 300 nm polyisoprene particles (weight-average molecular weight of polyisoprene: 200,000), an average molecular weight 500 of particles of polyvinyl alcohol (saponification: 96 mol % or higher), 1,2-hexandiol (hereinafter referred to as “1,2-HD”), 2-pyrrolidone (hereinafter referred to as “2-Py”), propylene glycol (hereinafter referred to as “PG”), BYK-348 as a surfactant, Proxel-XL2 (antiseptic, manufactured by Arch Chemicals Ltd., trade name), and ion-exchange water are added, and it was stirred for 20 min at 40° C. After stirring, it was filtered by the membrane-filter in the diameter of 5 μm, and the quantity (pts. mass) of the composition containing adhesive agent as shown in Table 1 was prepared.

2. Production of Recording Medium for Manufacturing Recorded Material

By using the composition containing adhesive agent obtained as described above, a recording medium for manufacturing recorded material was manufactured as follows.

Initially, a roll paper (manufactured by Seiko Epson Corporation, Super Fine paper roll type, 210 mm×20 m) was prepared as a recoding medium.

Next, in the state that the drive waveform of piezoelectric element was optimized, the composition containing adhesive agent was applied to whole surface of one side of the recording medium by the inkjet method. The application amount of the composition containing adhesive agent to the recording medium per unit was 30 g/m².

After that, by blowing 70° C. of warm air for 1 minute, the adhesive agent layer was formed. The thickness (dried film thickness) of the formed adhesive agent layer was 3 μm.

3. Formation of Image

The recording medium for manufacturing recorded material obtained as described above was cut in a predetermined length, and by using the inkjet printer (manufactured by Seiko Epson Corporation, PX-5002), a predetermined image was formed on the face opposing to the face on which the adhesive agent layer was formed.

### Examples 2 and 3

By changing the components used for manufacturing the composition containing adhesive agent and blending quantity, it becomes the composition as shown in Table 1, and by adjusting the application amount to the recording medium, it becomes the configuration of the recording medium for manufacturing recorded material as shown in Table 1. Other than that, the recording medium for manufacturing recorded material was manufactured and an image was formed in the same manner as Example 1 as described above.

### Comparative Example 1

1,2-HD, 2-Py, PG, emulsion type resin as an adhesive agent component, Polyzol AD17 (ethylene/vinyl acetate resin emulsion, glass transition temperature (Tg): −10° C., active component 56 mass %), BYK-348, Proxel-XL2, and ion-exchange water are mixed, and after stirring it at 40° C. for 20 minutes, it is filtered by the membrane-filter in the diameter of 5 μm so that the quantity (pts. mass) of the composition containing adhesive agent shown in Table 1 was prepared.

After that, the recording medium for manufacturing recorded material was manufactured in the same manner as Example 1 by using the obtained composition containing adhesive agent, and an image was formed.

### Comparative Example 2

1,2-HD, 2-Py, PG, emulsion type resin as an adhesive agent component, Polyzol AM710 (acrylate resin emulsion, glass transition temperature (Tg): 56° C., active component 51 mass %), BYK-348, Proxel-XL2, and ion-exchange water are mixed, and after stirring it at 40° C. for 20 minutes, it is filtered by the membrane-filter in the diameter of 5 μm so that the quantity (pts. mass) of the composition containing adhesive agent shown in Table 1 was prepared.

After that, the recording medium for manufacturing recorded material was manufactured in the same manner as Example 1 by using the obtained composition containing adhesive agent, and an image was formed.

The conditions of the compositions containing adhesive agent used for manufacturing the recording mediums for manufacturing recorded material, recorded materials in the aforementioned respective Examples and Comparative Examples, and the configurations of the adhesive agent layers of the recording mediums for manufacturing recorded material in the aforementioned respective Examples and Comparative Examples were summarized and shown in Table 1.

TABLE I

| | | | | | | | | | | | | | Manufacturing Condition | |
|---|---|---|---|---|---|---|---|---|---|---|---|---|---|---|
| | | | | | | | | | | | | | and Configuration of | |
| | | | | | | | | | | | | | Recording Medium for | |
| | | | | | | | | | | | | | Manufacturing Recorded | |
| | | | | | | | | | | | | | Material | |
| | | | | | | Content Ratio of Composition Containing | | | | | | | Applica- | Thick- |
| | Adhesive Agent Component | | | | | Adhesive Agent (mass %) | | | | | | | tion | ness of |
| | | | | Weight- | | Adhesive | Water-soluble | | | Surfac- | Anti- | | Amount | Adhesive |
| | | Average | | average | Tg | Agent | Organic Solvent | | | tant | septic | Ion- | (g/m²) to | Agent |
| | Type of | Particle | | Molecular | Resin | Component | 1,2- | 2- | | BYK- | Proxel- | exchange | Recording | Layer |
| | Resin | Diameter | | Weight | (° C.) | Resin | HD | Py | PG | 348 | XL2 | water | Medium | (μm) |
| Exam- | Poly- | 300 | nm | 200,000 | −60° C. | 9 | 5 | 4 | 12 | 1 | 02 | Residual | 30 | 3 |
| ple 1 | isoprene | | | | | | | | | | | | | |
| | Polyvinyl | — | | 500 | — | 1 | | | | | | | *Composition ratio = 9:1 | |
| | alcohol | | | | | | | | | | | | | |
| Exam- | Poly- | 100 | nm | 100,000 | −60° C. | 23.75 | 5 | 4 | 12 | 1 | 02 | Residual | 40 | 10 |
| ple 2 | isoprene | | | | | | | | | | | | | |
| | Polyvinyl | — | | 200 | — | 1.25 | | | | | | | *Composition ratio = 95:5 | |
| | alcohol | | | | | | | | | | | | | |
| Exam- | Poly- | 1 | μm | 500,000 | −60° C. | 1.875 | 5 | 4 | 12 | 1 | 02 | Residual | 100 | 2 |
| ple 3 | isoprene | | | | | | | | | | | | | |
| | Polyvinyl | — | | 2,000 | — | 0.625 | | | | | | | *Composition ratio = 75:25 | |
| | alcohol | | | | | | | | | | | | | |
| Comp- | Ethylene/ | 200 | nm | 200,000 | −10° C. | 10 | 5 | 4 | 12 | 1 | 02 | Residual | 30 | 3 |
| arative | Vinyl | | | | | | | | | | | | | |
| Exam- | acetate | | | | | | | | | | | | | |
| ple 1 | | | | | | | | | | | | | | |
| Comp- | Acrylate | 150 | nm | 200,000 | 56° C. | 10 | 5 | 4 | 12 | 1 | 02 | Residual | 30 | 3 |
| arative | | | | | | | | | | | | | | |
| Exam- | | | | | | | | | | | | | | |
| ple 2 | | | | | | | | | | | | | | |

*Composition ratio = Composition ratio of Resin in Adhesive Agent Layer Polyisoprene:Polyvinyl alcohol

4. Evaluation

4.1 Productivity

In the aforementioned respective Examples and Comparative Examples, the recording medium for manufacturing recorded material on which an image (print part) was formed was alternately folded in mountain fold and valley fold in a predetermined width, and 20 sheets, 40 pages were overlapped so as to oppose the parts each other where the adhesive agent layer of the recording medium for manufacturing recorded material was formed.

After that, it was pressed in a predetermined pressure for 3 minutes in the room temperature, and the photograph book as a recorded material was manufactured so that the productivity of the recorded material was evaluated according to the following standards.

AA: Enabling adhesion in the pressure less than 7 kg/cm² so that the productivity of the recorded material is excellent.

A: Enabling adhesion in the pressure more than or equal to 7 kg/cm² and less than 13 kg/cm² so that the productivity of the recorded material is excellent.

B: Enabling adhesion in the pressure more than or equal to 13 kg/cm² and less than 30 kg/cm² so that the productivity of the recorded material is good.

C: Enabling adhesion in the pressure more than or equal to 30 kg/cm² and less than 60 kg/cm² so that the productivity of the recorded material is slightly not-good.

D: Enabling adhesion in the pressure more than or equal to 60 kg/cm² and less than 100 kg/cm² so that the productivity of the recorded material is not-good.

E: Impossible to adhere in the pressure of 100 kg/cm² so that the productivity of the recorded material is immeasurable.

4.2 Adhesiveness (Appearance)

Each photograph book manufactured in the aforementioned 4.1 was visually observed, and the adhesiveness of the recorded materials was evaluated according to the following standards.

A: Recording medium for manufacturing recorded material is surely adhered, and unexpected floating, peeling, variation in thickness, and protrusion of adhesive agent are not recognized.

B: Recording medium for manufacturing recorded material is surely adhered, and unexpected floating, peeling, variation in thickness, and protrusion of adhesive agent are not almost recognized.

C: Recording medium for manufacturing recorded material is adhered, and at least one of unexpected floating, peeling, variation in thickness, and protrusion of adhesive agent is slightly recognized.

D: Recording medium for manufacturing recorded material is adhered, and at least one of unexpected floating, peeling, variation in thickness, and protrusion of adhesive agent is clearly recognized.

E: Recording medium for manufacturing recorded material is adhered, and at least one of unexpected floating, peeling, variation in thickness, and protrusion of adhesive agent is notably recognized.

4.3 Blocking Evaluation

For each recording medium for manufacturing recorded material manufactured in section 2 of the aforementioned respective Examples and Comparative Examples, it is wound in φ2 inch paper core under the predetermined environment and it is left for 1 hour. Then, it is tested whether or not the unexpected adhesion (blocking) between the surface for printing and the adhesive agent layer is generated, and it was evaluated according to the following standards.

A: Blocking is not generated under the environment of 40° C.

B: Blocking is not generated under the environment of more than or equal to 25° C. and less than 40° C.

C: Blocking is not generated under the environment of more than or equal to 5° C. and less than 25° C.

E: Blocking is generated under the environment of less than 5° C.

These results are shown in Table 2.

TABLE 2

| | | | Blocking |
|---|---|---|---|
| | Productivity | Adhesiveness | Evaluation |
| Example 1 | A | A | A |
| Example 2 | AA | A | A |
| Example 3 | A | A | A |
| Comparative Example 1 | B | D | E |
| Comparative Example 2 | E | — | A |

As is evident from Table 2, the satisfactory results were obtained in the embodiment, but the satisfactory results were not obtained in Comparative Examples. Specifically, in Comparative Example 1 that uses high stickiness adhesive agent in a state of nature, the workability for manufacturing recorded material was deteriorated due to the stickiness of the adhesive agent so that the productivity of the recorded material was deteriorated, and the appearance and the adhesion strength of the manufactured recorded material were deteriorated. Further, in Comparative Example 2 that uses the hot-melt adhesive agent, the workability of the production of the recording medium for manufacturing recorded material and the recorded material was improved in comparison with Comparative Example 1, but the adhesiveness in near the central portion in the thickness direction of the recorded material was not sufficient, and the appearance was also not good. By the way, when the composition containing adhesive agent of Comparative Example 1 was preliminary applied to the recording medium, and after that, an image formation was performed to the recorded material by the inkjet method, the paper jam was generated in the inside of the inkjet printer (liquid droplet discharge device) so that the desired image could not be formed.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

1. A recording medium for manufacturing recorded material in which a face opposing to an image forming face of a recording medium, which has an image formed by an inkjet method, is bonded, comprising:
a base material; and
an adhesive agent layer including polyisoprene.

2. The recording medium for manufacturing recorded material according to claim 1, wherein
a weight-average molecular weight of the polyisoprene is more than or equal to 100,000 and less than or equal to 500,000.

3. The recording medium for manufacturing recorded material according to claim 1, wherein
in addition to the polyisoprene, the adhesive agent layer includes a water-soluble resin.

4. The recording medium for manufacturing recorded material according to claim 3, wherein
the adhesive agent layer includes polyvinyl alcohol as the water soluble resin.

5. The recording medium for manufacturing recorded material according to claim 4, wherein
when a content rate of the polyisoprene in the adhesive agent layer is X_{A} (wt. %) and a content rate of polyvinyl alcohol in the adhesive agent layer is X_{B} (wt. %), a relationship of 3≦X_{A}/X_{B}≦19 is satisfied.

6. The recording medium for manufacturing recorded material according to claim 1, wherein
a content rate of the polyisoprene in the adhesive agent layer is more than or equal to 75 mass % and less than or equal to 95 mass %.

7. The recording medium for manufacturing recorded material according to claim 1, wherein
the base material is a roll paper.

8. The recording medium for manufacturing recorded material according to claim 1, wherein
a thickness of the adhesive agent layer is more than or equal to 1 μm and less than or equal to 10 μm.

9. A recorded material in which a face opposing to an image forming face of a recording medium, which has an image formed by the inkjet method, is bonded, the recorded material including a base material, and an adhesive agent layer including polyisoprene.
